(19) United States
(12) Patent Application Publication
(10) Pub. No.: US 2024/0044764 A1
(43) Pub. Date: Feb. 8, 2024

(54) STATE ESTIMATION DEVICE, STATE ESTIMATION METHOD, AND PROGRAM RECORDING MEDIUM

(71) Applicant: NEC Corporation, Minato-ku, Tokyo (JP)

(72) Inventor: Takashi KONASHI, Tokyo (JP)

(73) Assignee: NEC Corporation, Minato-ku, Tokyo (JP)

(21) Appl. No.: 18/267,423

(22) PCT Filed: Mar. 24, 2021
(86) PCT No.: PCT/JP2021/012139

§ 371 Date: Jun. 14, 2023

(51) Int. Cl. G01N 15/02

(52) U.S. Cl. CPC G01N 15/02

(57) ABSTRACT

A state estimation device includes an acquisition unit, an extraction unit, an estimation unit, and an output unit. The acquisition unit acquires first time series data pertaining to a generation environment of the targeted chemical substance. The extraction unit extracts a feature amount of the first time series data. The extraction unit extracts a feature amount of the first time series data. The estimation unit estimates, based on the feature amount of the first time series data, the state of the targeted chemical substance by using an estimation model trained, through machine learning, on the relationship between the state of the targeted chemical substance in the generation process and a feature amount of second time series data pertaining to the generation environment. The output unit outputs the estimated state.

### TECHNICAL FIELD

The present invention relates to a technique for estimating a state in a process of producing a chemical substance.

### BACKGROUND ART

It is important to confirm that normal processing has been performed or a product conforming to the standard has been produced in the production device of the chemical factory. However, in the production process, it is often difficult to directly confirm the internal state of the production device, and for example, in the case of producing a product using a chemical reaction, when the production is stopped in the middle of the production process in order to confirm the state of the targeted chemical substance to be produced, it is often impossible to obtain sufficient characteristics even when the production is restarted. PTL 1 and PTL 2 disclose as techniques for determining the state of an object.

PTL 1 relates to an abnormality detection method for detecting an abnormality of a plant. In the monitoring method of PTL 1, measurement data measured in a plant is used as input data, and an abnormality is detected using a machine-trained training model. PTL 2 discloses an example of a data processing method for detecting an abnormality using similarity between time series data.

### CITATION LIST

### Patent Literature

PTL 1: WO 2011/086805 A1
PTL 2: WO 2020/049666 A1

### SUMMARY OF INVENTION

### Technical Problem

However, in PTL 1 and PTL 2, it is difficult to estimate the state in a process of producing the product.

An object of the present invention is to provide a state estimation system and the like that solve the above-described problems.

### Solution to Problem

In order to solve the above problem, a state estimation device of the present invention includes an acquisition unit, an extraction unit, an estimation unit, and an output unit. The acquisition unit acquires first time series data pertaining to a production environment of the targeted chemical substance. The extraction unit extracts a feature amount of the first time series data. The estimation unit estimates, based on the feature amount of the first time series data, the state of the targeted chemical substance using an estimation model trained, through machine learning, on the relationship between the state of the targeted chemical substance in the production process and a feature amount of second time series data pertaining to the production environment. The output unit outputs the state estimated by the estimation unit.

A state estimation method of the present invention includes acquiring first time series data pertaining to a production environment of a targeted chemical substance. The state estimation method of the present invention includes extracting a feature amount of first time series data. The state estimation method of the present invention includes estimating, based on the feature amount of the first time series data, the state of the targeted chemical substance using an estimation model trained, through machine learning, on the relationship between the state of the targeted chemical substance in the production process and a feature amount of second time series data pertaining to the production environment. The state estimation method of the present invention includes outputting an estimated state.

A program recording medium of the present invention records a state estimation program. The state estimation program causes a computer to execute the step of acquiring first time series data pertaining to a production environment of a targeted chemical substance. The state estimation program causes a computer to execute the step of extracting a feature amount of the first time series data. The state estimation program causes a computer to execute the steps of estimating, on the basis of the feature amount of the first time series data, the state of the targeted chemical substance using an estimation model that was trained, through machine learning, on the relationship between the state of the targeted chemical substance in the production process and a feature amount of second time series data pertaining to the production environment. The state estimation program outputs an estimated state.

### Advantageous Effects of Invention

According to the present invention, it is possible to estimate a state in a process of producing a chemical substance even during production.

### BRIEF DESCRIPTION OF DRAWINGS

FIG. 1 is a diagram illustrating an outline of a configuration according to the first example embodiment of the present invention.

FIG. 2 is a diagram illustrating an example of a configuration of a state estimation device according to the first example embodiment of the present invention.

FIG. 3 is a diagram illustrating an example of an operation flow of the state estimation device according to the first example embodiment of the present invention.

FIG. 4 is a diagram illustrating an example of an operation flow of the state estimation device according to the first example embodiment of the present invention.

FIG. 5 is a diagram schematically illustrating an example of time series data of a measurement result according to the first example embodiment of the present invention.

FIG. 6 is a diagram illustrating an example of a display screen according to the first example embodiment of the present invention.

FIG. 7 is a diagram illustrating an example of a display screen according to the first example embodiment of the present invention.

FIG. 8 is a diagram illustrating an example of a configuration of a state estimation device according to the second example embodiment of the present invention.

FIG. 9 is a diagram illustrating an example of an operation flow of the state estimation device according to the second example embodiment of the present invention.

FIG. 10 is a view illustrating another configuration example of the example embodiment of the present invention.

### EXAMPLE EMBODIMENT

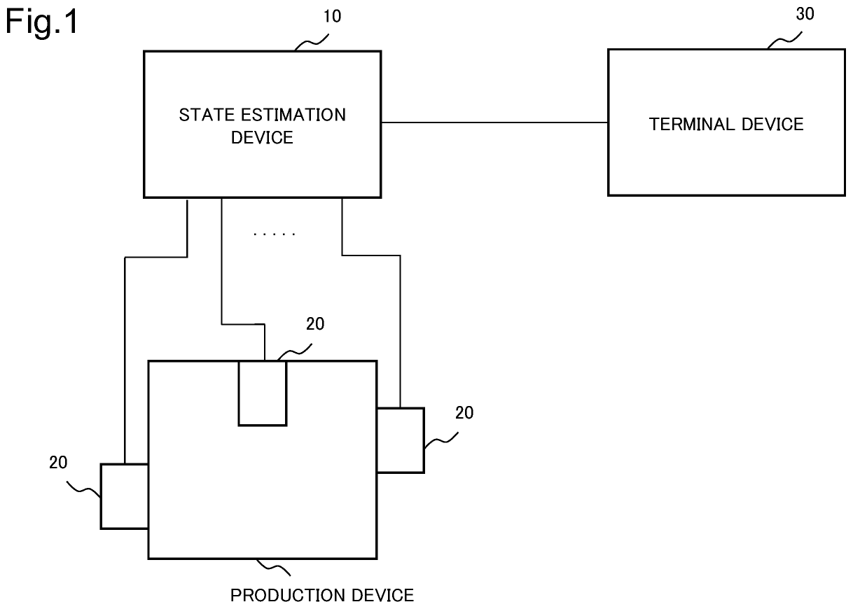

The first example embodiment of the present invention will be described in detail with reference to the drawings. FIG. 1 is a diagram illustrating an outline of a configuration of a state estimation system according to the present example embodiment. The state estimation system according to the present example embodiment includes a state estimation device 10, a sensor 20, and a terminal device 30. A plurality of sensors 20 is provided. The state estimation device 10 and each sensor 20 are connected via a network. The state estimation device 10 and the terminal device 30 are connected via a network.

The state estimation system according to the present example embodiment is a system that estimates a characteristic value of a product using measurement data by the sensor 20 in a process of producing a chemical substance. The state estimation system according to the present example embodiment acquires time-series measurement data for a predetermined time of the sensor 20 attached inside or outside the production device in the process of producing the product, and estimates a characteristic value in the process of producing the product using the acquired measurement data. Hereinafter, a product whose state is to be estimated in the production process is also referred to as a targeted chemical substance.

The state estimation system according to the present example embodiment generates reference data in advance using time series data of a measurement result by the sensor 20 when a product is produced in the past and a characteristic value of the product at a stage when production of the product is completed. The state estimation system estimates the characteristic value of the product using the similarity between the time series data measured in the process of producing the product and the reference data.

The product is, for example, a granular-shaped object (hereinafter, referred to as a “granular object”). In the case of a granular object, the characteristic value is, for example, a particle size. The granular object is, for example, a deoxidizing agent, a desiccant, an abrasive, a resin, a pharmaceutical product, or a powdered food product. The product may be an object of other properties, such as a liquid. The characteristic value may be viscosity, transmittance of light, chromaticity, or the like. The characteristic value may indicate a distribution of physical quantities indicating characteristics. In the following description, a case of estimating the particle size of the granular object using the measurement result by the sensor 20 will be described as an example.

The item of the data of the production environment measured by the sensor 20 is set using a physical quantity that changes according to the state and characteristics of the granular object in a process of producing the granular object. The items of the data of the production environment measured by the sensor 20 are set by selecting one or more physical quantities among, for example, vibration, pressure, temperature, load of the stirring device, transmittance of light inside the production device, and sound inside the device. The item of data measured by the sensor 20 may be set using a physical quantity other than the above. The sensors 20 that measure the same physical quantity may be installed at a plurality of places.

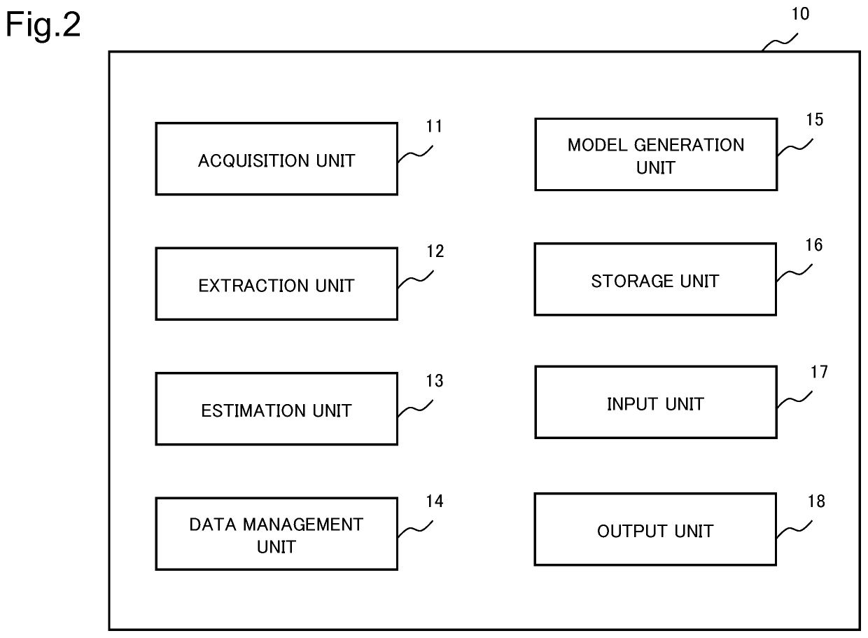

A configuration of the state estimation device 10 will be described. FIG. 2 is a diagram illustrating an example of a configuration of the state estimation device 10. The state estimation device 10 includes an acquisition unit 11, an extraction unit 12, an estimation unit 13, a data management unit 14, a model generation unit 15, a storage unit 16, an input unit 17, and an output unit 18.

At the time of generating the reference data, the acquisition unit 11 acquires time series data of measurement results measured by the plurality of sensors 20 when the granular object was produced in the past and data of the particle size in the final stage. That is, the acquisition unit 11 acquires the multidimensional time series data. The final stage refers to a time zone of a predetermined time including a time point at which the particle size of the granular object is a design value, that is, the particle size is a target value and the production is ended. The predetermined time is set in advance as a length at which the time series data of the measurement result by the sensor 20 reflects the characteristic. The acquisition unit 11 stores the time series data of the acquired measurement result and the data of the particle size at the final stage in the storage unit 16 in association with each other. The acquisition unit 11 acquires time series data of measurement results by the plurality of sensors 20 in the production process. The acquisition unit 11 stores the time series data of the acquired measurement result in the storage unit 16.

At the time of generating the reference data, the extraction unit 12 extracts the feature amount of the time series data from the time series data for a predetermined time at each of the initial stage and the final stage. The initial stage refers to, for example, a period from the start of generation until a predetermined time elapses. The predetermined time is preset as a length suitable for detecting the variation in the characteristic value of the granular object, or is set any value by the operator.

The extraction unit 12 extracts, as time series data at the initial stage, data from a time point at which generation is started until a predetermined time elapses among time series data of measurement results at the time of past manufacturing. In a case where the fluctuation of the measurement data is large immediately after the start, the start time point of the initial stage may be set to a time point when a preset time has elapsed from the start of production. The extraction unit 12 extracts the time series data, as the time series data at the final stage, from the data a predetermined time before the last data, that is, before the data when production is completed to the last data, among the time series data of the measurement results at the time of past generation.

In the production process, the extraction unit 12 extracts, as the time series data at the time point of estimating the particle size, data from the data a predetermined time before the data was obtained last to the data obtained last among the time series data stored in the storage unit 16. The extraction unit 12 extracts a feature amount of the time series data extracted in the production process.

The estimation unit 13 converts the extracted time series data for the measurement result of the predetermined time into a feature vector indicating a feature of the time series data for the predetermined time using an estimation model generated by machine training.

The estimation unit 13 converts time series data for a predetermined time, as input data, into a real number vector using an estimation model generated in advance by machine training, and further converts the real number vector into a binary vector, thereby converting the time series data for the predetermined time into a feature vector. The estimation unit 13 extracts a feature amount of time series data for a predetermined time by converting the time series data for the predetermined time into a feature vector using an estimation model. Generation of the estimation model will be described later.

The real number vector is a vector in which a value of each dimension takes a real number. The binary vector indicating the feature vector is a vector in which the value of each dimension takes one of two values such as 1 and −1 or 0 and 1.

The estimation model used when the estimation unit 13 performs data conversion is configured to convert S×T pieces of numerical data into an n-dimensional binary feature vector where the number of sensors is S, the number of time points is T, and the number of dimensions of the binary vector is n. The number of time points is the number of times at which the data is used for conversion by the estimation model among the times at which the time series data is measured within a predetermined time. When the number of data within the predetermined time is larger than the number of time points set in the estimation model, the extraction unit 12 extracts data for the number of time points set in the estimation model from the measurement data, and then performs conversion by the estimation model.

The estimation unit 13 uses a feature vector of the reference data read from the storage unit 16 and a feature vector obtained by converting the time series data of the measurement result in the production process to estimate the particle size at the current time, that is, at the time when the time series data is measured in the production process.

The estimation unit 13 estimates the particle size at the current time using a similarity between feature vectors at the initial stage of the reference data and of the measurement result at the current time and a similarity between feature vectors of the measurement result at the current time and at the final stage of the reference data. For example, the estimation unit 13 calculates the particle size at the current time from a Euclidean distance between the feature vectors at the initial stage of the reference data and at the current time, a Euclidean distance between the feature vectors at the current time and at the final stage of the reference data, and the particle size at the final stage of the reference data. The estimation unit 13 may calculate the distance between the feature vectors by a method other than the Euclidean distance as long as the distance between the feature vectors in the feature amount space can be calculated. For example, the estimation unit 13 may calculate the distance between the feature vectors using the Hamming distance.

At the time of generating the reference data, the data management unit 14 stores the data of the feature vector at the initial stage, the data of the feature vector at the final stage, and the data of the particle size at the final stage in the storage unit 16 in association with each other. The data of the feature vector at the initial stage and the data of the time series data before conversion into the feature vector at the final stage may be stored in further association with each other. The reference data is generated, for example, for each setting value of manufacturing conditions and particle size. For the reference data, the reference data is generated using the particle size at the final stage and the time series data measured at the time of manufacturing for each manufacturing condition and setting value of the particle size. The reference data may be set for each manufacturing condition.

At the time of estimating the particle size in the production process, the data management unit 14 reads, from the storage unit 16, the data of the feature vector at the initial stage, the data of the feature vector at the final stage, and the data of the particle size at the final stage, that are used for estimating the particle size. For example, the data management unit 14 identifies reference data that meets a condition input via the terminal device 30 by an operation by an operator, and reads the reference data from the storage unit 16. The data management unit 14 may read, from the storage unit 16, reference data in which the time series data measured in the production process and the data at the initial stage are similar.

The model generation unit 15 generates, by machine training, an estimation model used when the estimation unit 13 converts time series data for a predetermined time into a feature vector. The model generation unit 15 generates an estimation model by machine training using a recursive neural network, for example. The model generation unit 15 generates an estimation model by, for example, the method disclosed in WO 2020/049666 A1.

The model generation unit 15 performs machine training using time series measurement data for a plurality of predetermined times as training data, and generates a data estimation model that is a trained model. The model generation unit 15 performs machine training in such a way that a plurality of pieces of training data is converted into a plurality of real number vectors maintaining relative similarity between the plurality of pieces of training data. That is, the model generation unit 15 performs machine training in such a way that training data similar to each other is converted into real number vectors similar to each other, and training data not similar to each other is converted into real number vectors not similar to each other. The model generation unit 15 stores data of the generated estimation model in the storage unit 16.

The estimation model is generated for each production device, for example, and the reference data is generated for each production condition and particle size setting value. As long as the number of sensors 20 and the items to be measured are the same as the number of time points extracted from the time series data, the estimation model can be used even when they are different in the production conditions and the setting values of the particle size. Therefore, the estimation model is generated in advance for each type of the production device and each installation form of the sensor 20, and the reference data is generated for each product to be produced, so that the particle size of the granular object in the production process can be estimated.

The storage unit 16 stores data of the machine-learned estimation model generated by the model generation unit 15. The storage unit 16 stores time series data of the measurement result by the sensor 20 acquired by the acquisition unit 11. The storage unit 16 stores the feature vector converted from the time series data of the measurement result at the initial stage, the feature vector converted from the time series data of the measurement result at the final stage, and the particle size at the final stage in association with each other as reference data. The reference data is associated with information about the production condition and the target value of the particle size.

The input unit 17 acquires, from the terminal device 30, input data input to the terminal device 30 by the operation by the operator. The input unit 17 may acquire input data input by the operation by the operator from an input device connected to the state estimation device 10.

The output unit 18 outputs the estimation result of the particle size to the terminal device 30. The output unit 18 may output the estimation result of the particle size to a display device not illustrated connected to the state estimation device 10.

Each processing in the acquisition unit 11, the extraction unit 12, the estimation unit 13, the data management unit 14, the model generation unit 15, the input unit 17, and the output unit 18 can be performed, for example, by executing a computer program on a central processing unit (CPU). The processing in the acquisition unit 11, the extraction unit 12, the estimation unit 13, the data management unit 14, the model generation unit 15, the input unit 17, and the output unit 18 may be performed by another information processing device connected via a network.

The storage unit 16 is configured using, for example, a hard disk drive. The storage unit 16 may be configured by another type of storage device such as a nonvolatile semiconductor storage device or a combination of a plurality of types of storage devices. The storage unit 16 may be provided on a storage device connected to the state estimation device 10. The storage unit 16 may be provided on a storage device controlled by an information processing device connected via a network.

As the sensor 20, a sensor of a type related to a physical quantity to be measured is used. The sensor 20 measures a related physical quantity inside or outside the production device to transmit a measurement result to the state estimation device 10. The sensor 20 is installed to measure a physical quantity of the production environment, for example, in the production chamber of the production device or in the flow path of the product. The production environment is, for example, an atmosphere in the production chamber. The physical quantity of the production environment is, for example, a temperature in the production chamber. The physical quantity of the production environment may include a physical quantity of the product. The physical quantity of the production environment may be, for example, an item whose value changes as the chemical reaction of the product proceeds, such as the torque of the stirring device or the flow rate in the pipe.

The terminal device 30 displays display data of the particle size estimation result acquired from the state estimation device 10 on a display device not illustrated. The terminal device 30 transmits the manufacturing condition and the target value of the particle size input by the operation by the operator as input data to the state estimation device 10.

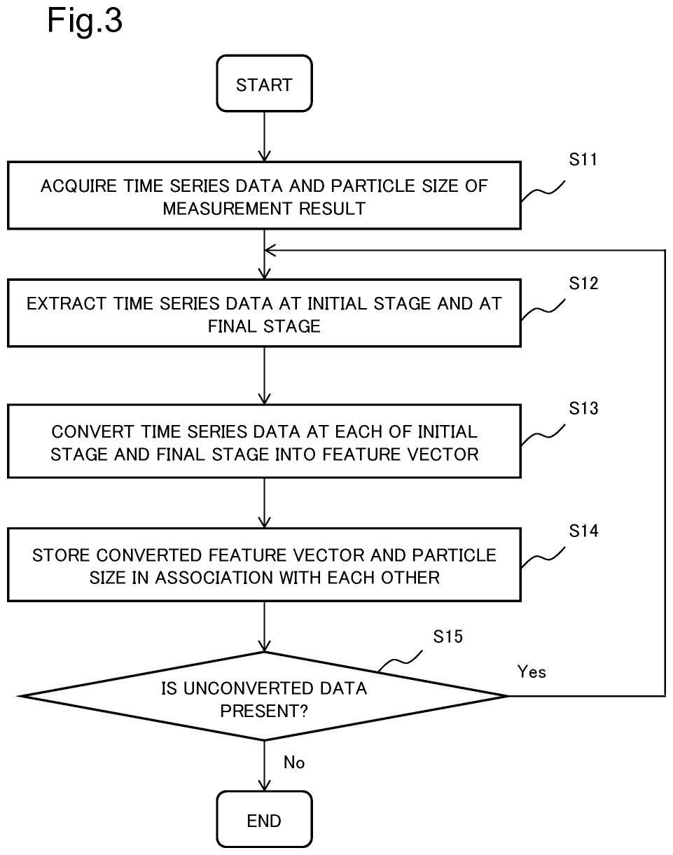

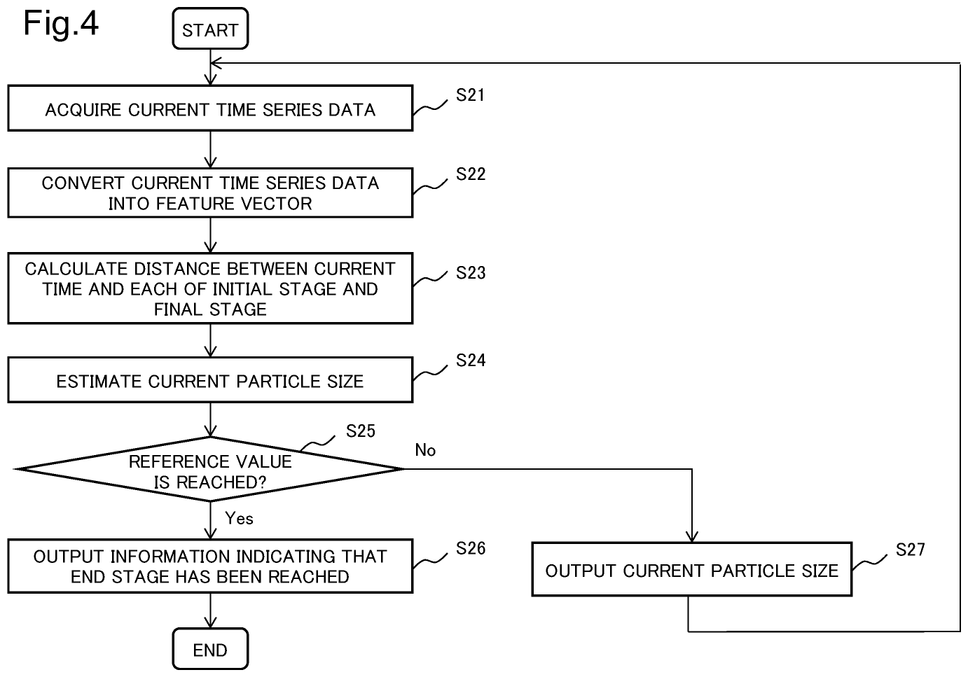

An operation of the state estimation system according to the present example embodiment will be described. FIGS. 3 and 4 are diagrams illustrating an example of an operation flow of the state estimation device 10.

In FIG. 3, the acquisition unit 11 of the state estimation device 10 acquires the time series data of the measurement data by the sensor 20 and the data of the particle size at the final stage when the granular object was manufactured in the past (step S11). The acquisition unit 11 acquires a production condition when the granular object is produced.

The acquisition unit 11 acquires, for example, time series data of measurement data by the sensor 20, data of the particle size at the final stage, and production conditions, when the granular object was produced in the past, stored in a production management server not illustrated via a network. The time series data of the measurement data by the sensor 20, the data of the particle size at the final stage, and the production condition when the granular object was produced in the past may be input to the terminal device 30 by the operation by the operator and acquired from the terminal device 30. The acquisition unit 11 stores the acquired time series data of the measurement data by the sensor 20, the data of the particle size at the final stage, and the production condition when the granular object acquired was produced in the past in the storage unit 16.

When the time series data of the measurement data and the data of the particle size at the final stage are stored in the storage unit 16, the extraction unit 12 extracts time series data of the measurement result for a predetermined time at each of the initial stage and the final stage from the stored data (step S12). The extraction unit 12 extracts a feature amount from time series data for a predetermined time. The extraction unit 12 extracts data of a preset number of time points as a feature amount for a preset item among the measurement data obtained by measuring the production environment. When the number of data is larger than the preset number of time points, the extraction unit 12 extracts data for the preset number of time points. For example, the extraction unit 12 extracts data for a preset number of time points from the time series data for a predetermined time in such a way that time intervals of the extracted data are uniform.

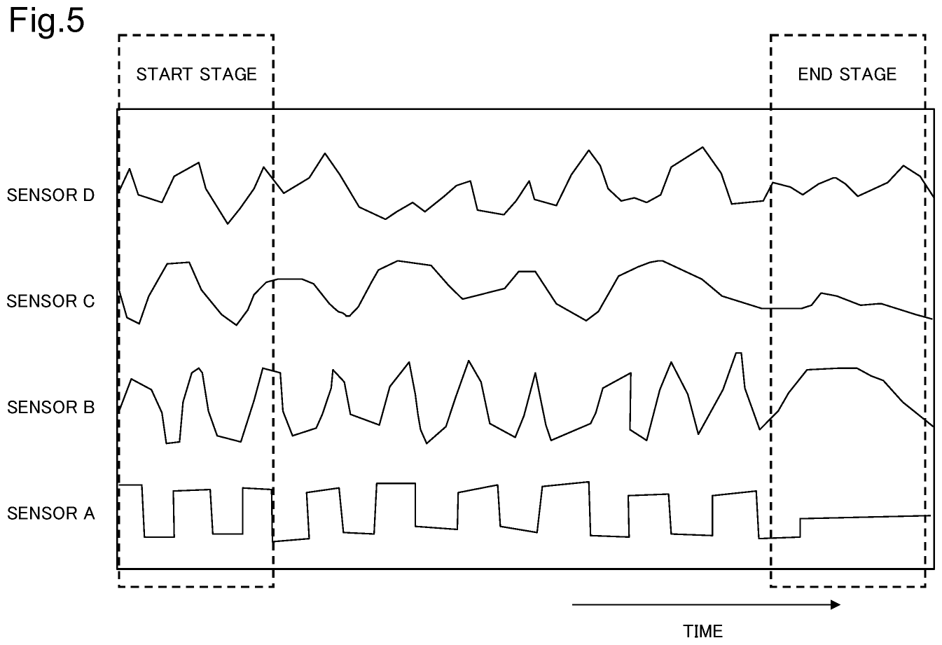

FIG. 5 is a diagram schematically illustrating an example of time series data measured by four sensors. FIG. 5 illustrates time series data of measurement results by a sensor A, a sensor B, a sensor C, and a sensor D. The extraction unit 12 extracts data in a dotted line denoted as the start stage and the end stage in FIG. 5 as time series data for a predetermined time. In FIG. 5, the horizontal axis represents time, and the vertical axis schematically represents a change in the measurement value.

In FIG. 3, when the feature amount is extracted, the estimation unit 13 converts the time series data of the measurement result at each of the initial stage and the final stage into a real number vector using the estimation model, and further converts the real number vector into a binary vector to convert the binary vector into a feature vector (step S13). When converted into the feature vector, the estimation unit 13 stores the data of the feature vector at the initial stage and the feature vector at the final stage, the data of the particle size at the final stage, and the production condition as reference data in association with each other in the storage unit 16 (step S14). When the particle size is estimated, the data of the particle size at the final stage is also used as information of a target value of the particle size when the reference data is selected. As the information of the target value of the particle size in the reference data, a setting value that is a target when the measurement data that is the basis of the reference data is measured, or a value input via the terminal device 30 by the operation by the operator may be used.

When there is the time series data of the unconverted measurement result when the data of the feature vector and the data of the particle size at the final stage are stored in the storage unit 16 (Yes in step S15), the state estimation device 10 returns to step S12 and performs the processing of converting the time series data of the unconverted measurement result into the feature vector. When the conversion processing on all the acquired measurement data has been completed (No in step S15), the state estimation device 10 ends the operation of generating the reference data.

Next, an operation in a case where the state estimation device 10 estimates the particle size in a process of producing the granular object will be described.

When the production of the granular object is started, the input unit 17 acquires, from the terminal device 30, input data of a selection result of the reference data according to the production condition and the target value of the particle size input to the terminal device 30 by the operation by the operator. When the input data of the selection result of the reference data is acquired, the data management unit 14 reads the related reference data from the storage unit 16.

In FIG. 4, the acquisition unit 11 acquires time series data of the measurement result from the sensor 20 in the process of producing the granular object (step S21). When the time series data is acquired, the extraction unit 12 extracts the feature amount from the time series data from the data of the past time to the most recently acquired data for the predetermined time and the time series data for the predetermined time at the current time. When the feature amount is extracted, the estimation unit 13 uses the time series data at the current predetermined time as input data, converts the time series data into a real number vector using the estimation model, and further converts the real number vector into a binary vector to convert the binary vector into a feature vector (step S22).

When the feature amount of the current time series data is converted into the feature vector, the estimation unit 13 uses the feature vector converted from the current time series data and the feature vectors at the initial stage and at the final stage to calculate a distance in the feature amount space between the current time and the initial stage and a distance in the feature amount space between the current time and the final stage (step S23). After calculating the distances in the feature amount spaces, the estimation unit 13 estimates the particle size at the current time using each calculated distance and the data of the particle size at the final stage included in the reference data (step S24).

The estimation unit 13 calculates, for example, the ratio of a distance between the initial stage and the current time to a distance between the current time and the end stage, and uses the ratio as the degree of progress of the production of the granular object, thereby estimating the particle size at the current stage using the particle size at the final stage. For example, the estimation unit 13 calculates the particle size at the current time by an expression of (A/(A+B))×R where A is a distance between the initial stage and the current time, B is a distance between the current time and the end stage, 0 is a particle size at the initial stage, and R is a particle size at the final stage. When the particle size at the initial stage is R_{I}, the particle size at the final stage is R_{F}, and the particle size increases with the progress, R=R_{F}−R_{I}. When the particle size at the initial stage is R_{I}, the particle size at the final stage is R_{F}, and the particle size decreases with the progress, R=R_{I}−R_{F}R_{I}.

When the particle size is estimated, the estimation unit 13 identifies whether the particle size reaches the reference value. The estimation unit 13 identifies that the final stage has been reached when the particle size at the current time is, for example, equal to or more than the reference value, and identifies that it is a time of the intermediate stage when the particle size is less than the reference value. When the granular object is a product produced by finely dividing a large lump, the estimation unit 13 identifies that the final stage has been reached when the particle size at the current time is equal to or less than the reference value, and identifies that it is a time of the intermediate stage when the distance is larger than the reference value. The estimation unit 13 may calculate a distance between the feature vector converted from the current time series data and the feature vector at the final stage, identify that the final stage has been reached when the distance is within the reference value, and identify that it is a time of the intermediate stage when the distance is larger than the reference value.

When it is identified that the particle size does not reach the reference value and it is a time of the intermediate stage when the particle size is estimated in step S24 (No in step S25), the output unit 18 outputs data of the estimation result of the particle size to the terminal device 30 (step S27). When receiving the estimation result of the particle size, the terminal device 30 displays the estimation result of the particle size on a display device not illustrated. When the data of the estimation result of the particle size is output, the state estimation device 10 performs the process again from the process of acquiring the current time series data in step S21, and continues estimation of the particle size in the production process.

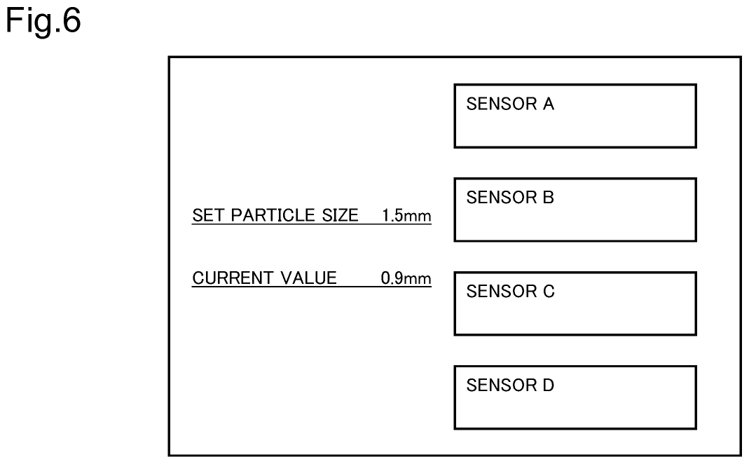

FIG. 6 is a diagram schematically illustrating an example of a display screen of an estimation result of the particle size. In the example of FIG. 6, the target value of the particle size is illustrated as the set particle size, and the estimation value of the particle size is illustrated as the current value. The right side of FIG. 6 illustrates an example in which current measurement values of the current sensors A, B, C, and D to are displayed. The measurement value of the sensor is output in addition to the estimation result by the state estimation device 10, for example. The measurement value of the sensor may be displayed as time series data of the measurement result used when the particle size is estimated. When the measurement value of the sensor is displayed as the time series data, the time series data at the final stage used for generating the reference data may be displayed together, so that the difference from the current measurement data can be visually recognized.

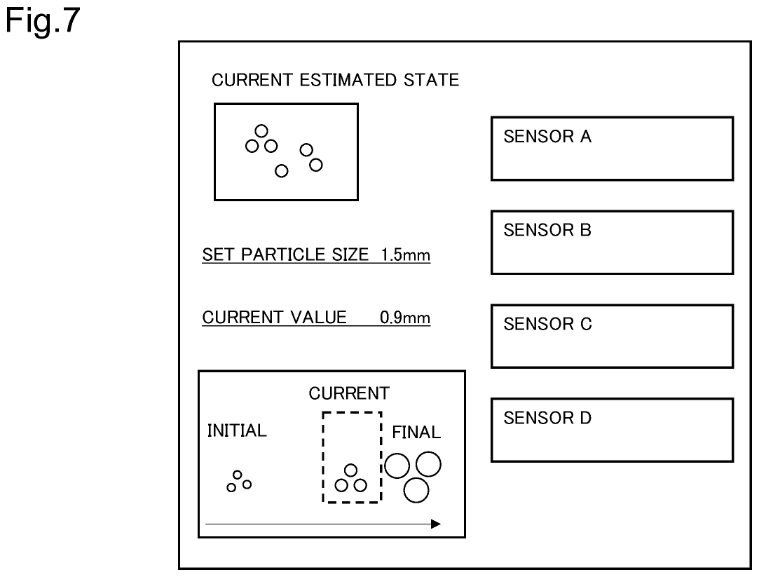

FIG. 7 is a diagram schematically illustrating an example of a display screen on which a diagram of an estimation result of the particle size is further displayed on the display screen of FIG. 6. The upper left part of FIG. 7 illustrates an estimated state of the granular object generated using the estimation result of the current particle size as the current estimated state. The lower left part of FIG. 7 illustrates states at the initial stage and the final stage, and further illustrate the current estimated state in such a way that it is possible to visually recognize at which position between the initial stage and the final stage the estimated state at the current time is. In this way, by displaying the current estimated state, the operator who manages the production step can more easily recognize the current state.

When it is identified in step S25 of FIG. 4 that the particle size has reached the reference value and it is a time of the final stage (Yes in step S25), the output unit 18 transmits information indicating that the final stage has been reached and the estimated particle size as data of the estimation result to the terminal device 30 (step S26).

When receiving the data of the estimation result including the information indicating that the final stage has been reached, the terminal device 30 displays the information indicating that the final stage has been reached and the estimation result of the particle size on a display device not illustrated. The operator can end the production of the granular product by confirming the information indicating that the final stage has been reached. The information indicating that the final stage has been reached may be output to a control device of the device, and the control device may end the granular object production step. When the information indicating that the final stage has been reached and the data of the estimation result of the estimated particle size are output in step S26, the state estimation device 10 ends the operation related to the particle size estimation process.

In the above description, the data management unit 14 reads the reference data according to the input result from the storage unit 16, but may read reference data having similar time series data at the initial stage of the production process from the storage unit 16. In such a configuration, in the production process, time series data at the initial stage is acquired by the acquisition unit 11 and converted into a binary feature vector by the extraction unit 12. The estimation unit 13 calculates the distance between the feature vector obtained by converting the time series data at the initial stage in the production process and the feature vector at the initial stage stored as the reference data, and identifies the reference data that is similar at the initial stages. The estimation unit 13 estimates the particle size at the current time using the identified reference data and the feature vector converted from the measurement data acquired in the production process.

When generating an estimation model by machine training, the model generation unit 15 may use a product production condition as input data. When the production condition is used in generating the estimation model, the estimation unit 13 can estimate the particle size from the production condition and the feature amount of the time series data in the production process without acquiring the selection result of the production condition input by the operation by the operator in the production process. As the production conditions of the product, for example, one or more items of the pressure in the production device, the temperature in the production device, the input amount of the raw material, the input speed of the raw material, the input pressure of the raw material, the stirring speed, and the stirring torque are used. The product production conditions may be items other than the above.

In the above description, the particle size at the current time is estimated with the feature vector converted from the time series data of each of the two sections of the initial stage and at the final stage at the time of production in the past as a reference, but a stage serving as a reference may be further set between the initial stage and the final stage. In such a configuration, the extraction unit 12 extracts the time series data for a predetermined time between the initial stage and the final stage, and converts the time series data into a feature vector. The data management unit 14 stores the converted feature vectors in the storage unit 16 as reference data in association with the feature vectors at the initial stage and at the final stage as the feature vectors at the intermediate stage. When the time series data at the intermediate stage is measured, the data management unit 14 further associates and stores data of the particle size of the granular object measured by extraction of a product or the like.

In the production process, the estimation unit 13 calculates the distance between the stages using the feature vector converted from the measurement data and the feature vector at each stage of the reference data, and identifies whether the current time is between the initial stage and the intermediate stage or between the intermediate stage and the final stage. When the current time is between the initial stage and the intermediate stage, the estimation unit 13 estimates the particle size at the current time using the ratio of the particle size at the intermediate stage to the distance. When the current time is between the intermediate stage and the final stage, the estimation unit 13 estimates the particle size at the current time using the ratio of the difference between the particle size at the intermediate stage and the particle size at the final stage to the distance.

It is assumed that the measurement data of the time series at the final stage is the second time series data, the measurement data of the time series at the initial stage is the third time series data, the measurement data of the time series at the intermediate stage is the fourth time series data, and the measurement data of the time series at the current time is the first time series data. The extraction unit 12 converts the second time series data into a second feature vector, the third time series data into a third feature vector, the fourth time series data into a fourth feature vector, and the first time series data into a first feature vector. At this time, the estimation unit 13 calculates a distance between the first feature vector at the current time and each of the third feature vector at the initial stage, the second feature vector at the final stage, and the fourth feature vector at the intermediate stage of the reference data.

When there is no reference data at the intermediate stage, the estimation unit 13 estimates the particle size at the current time, that is, when the first time series data is acquired, using a distance between the first feature vector and the second feature vector, a distance between the first feature vector and the third feature vector, and a particle size at the time of measurement of the second time series data.

When there is the reference data at the intermediate stage, the estimation unit 13 calculates a distance between the first feature vector and the second feature vector, a distance between the first feature vector and the third feature vector, and a distance between the first feature vector and the fourth feature vector. When the first time series data at the current time is before the intermediate stage, it estimates the particle size at the current time, that is, when the first time series data is acquired using a distance between the first feature vector and the third feature vector, a distance between the first feature vector and the fourth feature vector, and a particle size at the time of measurement of the fourth time series data. When the current measurement data is after the intermediate stage, it estimates the particle size at the current time, that is, when the first time series data is acquired using a distance between the first feature vector and the fourth feature vector, a distance between the first feature vector and the second feature vector, a particle size at the time of measuring the fourth time series data, and a particle size at the time of measuring the second time series data. When the particle size at the initial stage is other than 0, the particle size data at the initial stage is associated with the reference data, and the estimation unit 13 estimates the particle size at the current time by also using the particle size at the initial stage. By increasing the reference in this way, since the current time and the measurement time points of the two reference data are close to each other, the accuracy of the estimation of the particle size by the state estimation device 10 is improved. There may be a plurality of intermediate stages. The estimation unit 13 may estimate the particle size at the current time using a distance between the feature vectors at the current time and at the final stage and a distance between the feature vectors at the initial stage and the final stage.

The output unit 18 may output, to the terminal device 30, the progress status of the production process and the information about the advice to the operator using the estimation result by the estimation unit 13. For example, the estimation unit 13 compares the speed of expansion of the particle size with the actual data. In the comparison, for example, when the expansion of the particle size is fast, the estimation unit 13 estimates that the quality may be deteriorated. The estimation unit 13 identifies the speed of progress using, for example, a ratio of the time from the initial stage to the final stage to the elapsed time until the current time, and a ratio of the current particle size and the particle size at the final stage. In a case where there is the reference data at the intermediate stage, the estimation unit 13 may identify the speed of expansion of the particle size using the time from the start of production to the arrival at each stage and the particle size at each stage using a time to reach each stage where the time is stored in the storage unit 16 in association with the feature vector at each stage.

The output unit 18 outputs sentences such as “manufacturing speed is fast” as the progress status and “please lower the temperature because the particle size is rapidly increased and quality deterioration is likely to occur” as the advice to the terminal device 30 according to the estimation by the estimation unit 13. For example, when the estimation unit 13 estimates that the expansion of the particle size is slow, the output unit 18 outputs sentences such as “manufacturing speed is slow” as the progress to status and “expansion of the particle size is slow and quality deterioration is likely to occur, so add catalyst A” as the advice to the terminal device 30. The related relationship between the estimation result by the estimation unit 13 and the output sentence is stored in advance in the storage unit 16.

The state estimation device 10 according to the present example embodiment extracts time series data for a predetermined time at each of the initial stage and the final stage from multi-dimensional time series data measured by a plurality of sensors 20 when a granular object is produced, converts the time series data into a feature vector using an estimation model, and stores the feature vector as reference data. In the process of producing the granular object, the state estimation device 10 extracts data for a predetermined time from the time-series measurement data by the plurality of sensors 20 and converts the data into a feature vector using the estimation model. The state estimation device 10 estimates the current particle size by calculating the distance between the feature vector converted from the current time series data in the process of producing the granular object and the feature vector of the reference data generated in advance. As described above, the state estimation device 10 generates the reference data in advance, and estimates the particle size using the conversion of the measurement data at the current time into the feature vector and the distance between the feature vectors in the production process, so that the state of the product can be estimated even when the internal state cannot be confirmed. In the state estimation device 10 according to the present example embodiment, the state estimation device 10 generates the reference data in advance, and in the production process, performs only the conversion of the measurement data at the current time into the feature vector and the process of estimating the particle size using the distance between the feature vectors, whereby the processing amount of data can be suppressed. By suppressing the processing amount of necessary data, the state estimation device 10 can suppress the time required for estimating the particle size in the production process and can estimate the state of the product in real time. As a result, the state estimation system according to the present example embodiment can estimate the state in the process of producing the chemical substance even in the middle of production.

### Second Example Embodiment

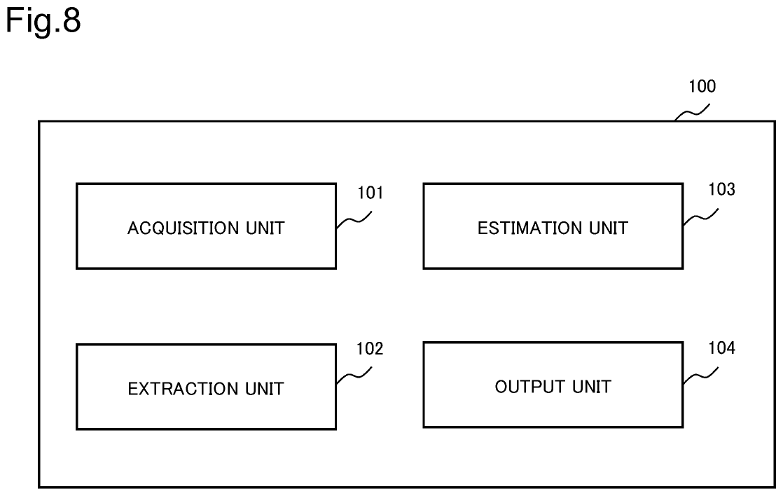

The second example embodiment of the present invention will be described in detail with reference to the drawings. FIG. 8 is a diagram illustrating an example of a configuration of a state estimation device 100 according to the present example embodiment. The state estimation device 100 includes an acquisition unit 101, an extraction unit 102, an estimation unit 103, and an output unit 104.

The acquisition unit 101 acquires first time series data pertaining to a production environment of the targeted chemical substance. The targeted chemical substance is a product to be subjected to estimation of the state thereof in the production process via a chemical reaction. The extraction unit 102 extracts a feature amount of the first time series data. The extraction unit 102 extracts a feature amount of the first time series data. The estimation unit 103 estimates, based on the feature amount of the first time series data, the state of the targeted chemical substance using an estimation model that was trained, through machine learning, on the relationship between the state of the targeted chemical substance in the production process and the feature amount of the second time series data pertaining to the production environment. The output unit outputs the state estimated by the estimation unit. The output unit 104 outputs the state estimated by the estimation unit 103. The acquisition unit 11 according to the first example embodiment is an example of the acquisition unit 101. The acquisition unit 101 is an aspect of an acquisition means. The extraction unit 12 is an example of the extraction unit 102. The extraction unit 102 is an aspect of an extraction means. The estimation unit 13 and the data management unit 14 are an example of the estimation unit 103. The estimation unit 103 is an aspect of an estimation means. The output unit 18 is an example of the output unit 104. The output unit 104 is an aspect of an output means.

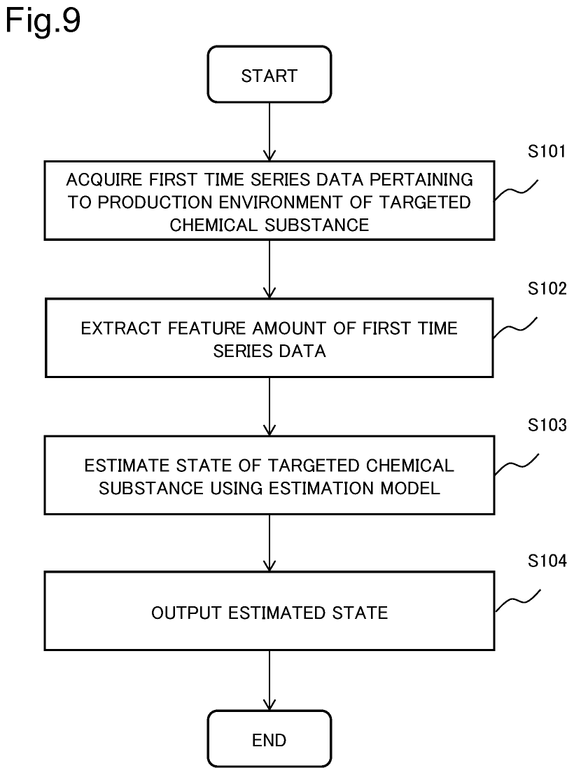

The operation of the state estimation device 100 according to the present example embodiment will be described. FIG. 9 is a diagram illustrating an example of an operation flow of the state estimation device 100. The acquisition unit 101 acquires first time series data pertaining to a production environment of the targeted chemical substance. (step S101). The extraction unit 102 extracts a feature amount of the first time series data (step S102). Based on the feature amount of the first time series data, the estimation unit 103 estimates the state of the targeted chemical substance using an estimation model that was trained, through machine learning, on the relationship between the state of the targeted chemical substance in the production process and the feature amount of the second time series data pertaining to the production environment (step S103). The output unit 104 outputs the estimated state (step S104).

In the state estimation device 100 according to the present example embodiment, the acquisition unit 101 acquires time series data of a targeted chemical substance, and the extraction unit 102 extracts a feature amount of the time series data. The estimation unit 103 estimates the state of the targeted chemical substance from the feature amount of the first time series data using the estimation model generated from the second time series data of the production environment when the targeted chemical substance is produced and the state of the targeted chemical substance. As described above, by estimating the state, the state estimation device 10 according to the present example embodiment can estimate the state in the process of producing the chemical substance even in the middle of production.

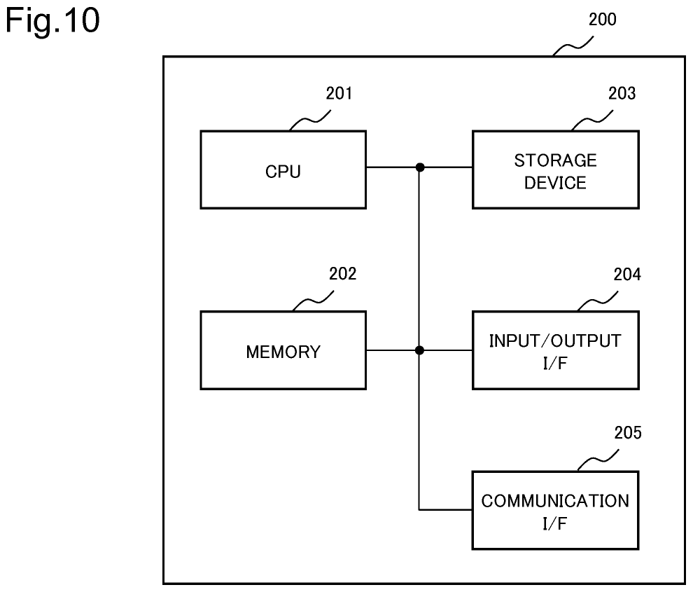

Each processing in the state estimation device 10 according to the first example embodiment and the state estimation device 100 of the second example embodiment can be performed by executing a computer program on a computer. FIG. 10 illustrates an example of a configuration of a computer 200 that executes a computer program for executing each processing in the state estimation device 10 according to the first example embodiment and the state estimation device 100 of the second example embodiment. The computer 200 includes a CPU 201, a memory 202, a storage device 203, an input/output interface (I/F) 204, and a communication I/F 205.

The CPU 201 reads and executes a computer program for executing each processing from the storage device 203. The CPU 201 may be configured by a combination of a CPU and a graphics processing unit (GPU). The memory 202 includes a dynamic random access memory (DRAM) or the like, and temporarily stores a computer program executed by the CPU 201 and data being processed. The storage device 203 stores a computer program executed by the CPU 201. The storage device 203 includes, for example, a nonvolatile semiconductor storage device. The storage device 203 may include another storage device such as a hard disk drive. The input/output I/F 204 is an interface that receives an input from an operator and outputs display data and the like. The communication I/F 205 is an interface that transmits and receives data to and from the sensor 20 and the terminal device 30. The terminal device 30 can have a similar configuration.

The computer program used for executing each processing can also be stored in a recording medium and distributed. The recording medium may include, for example, a magnetic tape for data recording or a magnetic disk such as a hard disk. The recording medium may include an optical disk such as a compact disc read only memory (CD-ROM). A non-volatile semiconductor storage device may be used as a recording medium.

Some or all of the above example embodiments may be described as the following Supplementary Notes, but are not limited to the following.

### [Supplementary Note 1]

A state estimation device including
an acquisition means configured to acquire first time series data pertaining to a production environment of a targeted chemical substance,
an extraction means configured to extract a feature amount of the first time series data,
an estimation means configured to estimate a state of the targeted chemical substance using an estimation model trained, through machine learning, on a relationship between a state of the targeted chemical substance and a feature amount of second time series data pertaining to the production environment in a production process based on the feature amount of the first time series data, and
an output means configured to output the state estimated by the estimation means.

### [Supplementary Note 2]

The state estimation device according to Supplementary Note 1, wherein
the state, of the targeted chemical substance, estimated by the estimation means is at least one of a size of the targeted chemical substance in a production process, a degree of progress in the production process, or whether the state of the targeted chemical substance is a normal state.

### [Supplementary Note 3]

The state estimation device according to Supplementary Note 1 or 2, wherein
the output means outputs a diagram or an image related to the state of the targeted chemical substance estimated by the estimation means.

### [Supplementary Note 4]

The state estimation device according to any one of Supplementary Notes 1 to 3, wherein
the first time series data is at least one of time series data of a temperature in a process of producing the targeted chemical substance, time series data of a sound emitted by a production device that produces the targeted chemical substance, and time series data of a vibration of the production device.

### [Supplementary Note 5]

The state estimation device according to any one of Supplementary Notes 1 to 4, wherein
the estimation means estimates a time until production of the targeted chemical substance is completed, and wherein
the output means outputs the time estimated by the estimation means.

### [Supplementary Note 6]

The state estimation device according to any one of Supplementary Notes 1 to 5, wherein
when a characteristic value indicating a state of the targeted chemical substance estimated by the estimation means satisfies a predetermined condition criterion,
the output means outputs information indicating that the production is completed.

### [Supplementary Note 7]

The state estimation device according to any one of Supplementary Notes 1 to 6, wherein
the estimation means estimates a progress status and advice of a production process based on the estimated state and a production time from a start of production of the targeted chemical substance until the state is reached, and wherein
the output means outputs the progress status and the advice.

### [Supplementary Note 8]

The state estimation device according to any one of Supplementary Notes 1 to 7, wherein
the estimation model is generated by further machine learning on a production condition of the targeted chemical substance.

### [Supplementary Note 9]

The state estimation device according to any one of Supplementary Notes 1 to 8, further including
a generation means configured to generate the estimation model.

### [Supplementary Note 10]

A state estimation method including
acquiring first time series data pertaining to a production environment of a targeted chemical substance,
extracting a feature amount of the first time series data,
estimating a state of the targeted chemical substance using an estimation model trained, through machine learning, on a relationship between a state of the targeted chemical substance and a feature amount of second time series data pertaining to the production environment in a production process based on the feature amount of the first time series data, and
outputting the estimated state.

### [Supplementary Note 11]

The state estimation method according to Supplementary Note 10, wherein
the estimated state of the targeted chemical substance is at least one of a size of the targeted chemical substance in a production process, a degree of progress in the production process, or whether the state of the targeted chemical substance is a normal state.

### [Supplementary Note 12]

The state estimation method according to Supplementary Note 10 or 11, the method including
outputting a diagram or an image related to the estimated state of the targeted chemical substance.

### [Supplementary Note 13]

The state estimation method according to any one of Supplementary Notes 10 to 12, wherein
the first time series data is at least one of time series data of a temperature in a process of producing the targeted chemical substance, time series data of a sound emitted by a production device that produces the targeted chemical substance, and time series data of a vibration of the production device.

### [Supplementary Note 14]

The state estimation method according to any one of Supplementary Notes 10 to 13, the method including
estimating a time until production of the targeted chemical substance is completed, and
outputting the estimated time.

### [Supplementary Note 15]

The state estimation method according to any one of Supplementary Notes 10 to 14,
when a characteristic value indicating an estimated state of the targeted chemical substance satisfies a predetermined condition criterion,
the method including outputting information indicating that the production is completed.

### [Supplementary Note 16]

The state estimation method according to any one of Supplementary Notes 10 to 15, the method including
estimating a progress status and advice of a production process based on the estimated state and a production time from a start of production of the targeted chemical substance until the state is reached, and
outputting the progress status and the advice.

### [Supplementary Note 17]

The state estimation method according to any one of Supplementary Notes 10 to 16, wherein
the estimation model is generated by further machine learning on a production condition of the targeted chemical substance.

### [Supplementary Note 18]

A program recording medium recording a state estimation program for causing a computer to execute the steps of
acquiring first time series data pertaining to a production environment of a targeted chemical substance,
extracting a feature amount of the first time series data,
estimating a state of the targeted chemical substance using an estimation model trained, through machine learning, on a relationship between a state of the targeted chemical substance and a feature amount of second time series data pertaining to the production environment in a production process based on the feature amount of the first time series data, and
outputting the estimated state.

The present invention is described above using the above-described example embodiments as exemplary examples. However, the present invention is not limited to the above-described example embodiments. That is, it will be understood by those of ordinary skill in the art that the present invention can have various aspects without departing from the spirit and scope of the present invention as defined by the claims.

### REFERENCE SIGNS LIST

10 state estimation device
11 acquisition unit
12 extraction unit
13 estimation unit
14 data management unit
15 model generation unit
16 storage unit
17 input unit
18 output unit
20 sensor
30 terminal device
100 state estimation device
101 acquisition unit
102 extraction unit
103 estimation unit
200 computer
201 CPU
202 memory
203 storage device
204 input/output I/F
205 communication I/F

What is claimed is:

1. A state estimation device comprising:
at least one memory storing instructions; and
at least one processor configured to access the at least one memory and execute the instructions to:
acquire first time series data pertaining to a production environment of a targeted chemical substance;
extract a feature amount of the first time series data;
estimate a state of the targeted chemical substance using an estimation model trained, through machine learning, on a relationship between a state of the targeted chemical substance and a feature amount of second time series data pertaining to the production environment in a production process based on the feature amount of the first time series data; and
output the estimated state estimated.

2. The state estimation device according to claim 1, wherein
the estimated state, of the targeted chemical substance, is at least one of a size of the targeted chemical substance in a production process, a degree of progress in a production process, or whether the state of the targeted chemical substance is a normal state.

3. The state estimation device according to claim 1, wherein
the at least one processor is further configured to execute the instructions to:
output a diagram or an image related to the estimated state of the targeted chemical substance.

4. The state estimation device according to claim 1, wherein
the first time series data is at least one of time series data of a temperature in a process of producing the targeted chemical substance, time series data of a sound emitted by a production device that produces the targeted chemical substance, and time series data of a vibration of the production device.

5. The state estimation device according to claim 1, wherein
the at least one processor is further configured to execute the instructions to:
estimate a time until production of the targeted chemical substance is completed; and
output the estimated time estimated.

6. The state estimation device according to claim 1, wherein
the at least one processor is further configured to execute the instructions to:
when a characteristic value indicating the estimated state of the targeted chemical substance satisfies a predetermined condition criterion,
output information indicating that the production is completed.

7. The state estimation device according to claim 1, wherein
the at least one processor is further configured to execute the instructions to:
estimate a progress status and advice of a production process based on the estimated state and a manufacturing time from a start of production of the targeted chemical substance until the state is reached; and
output the progress status and the advice.

8. The state estimation device according to claim 1, wherein
the estimation model is generated by further machine learning on a production condition of the targeted chemical substance.

9. The state estimation device according to claim 1, wherein
the at least one processor is further configured to execute the instructions to:
generate the estimation model.

10. A state estimation method comprising:
acquiring first time series data pertaining to a production environment of a targeted chemical substance;
extracting a feature amount of the first time series data;
estimating a state of the targeted chemical substance using an estimation model trained, through machine learning, on a relationship between a state of the targeted chemical substance and a feature amount of second time series data pertaining to the production environment in a production process based on the feature amount of the first time series data; and
outputting the estimated state.

11. The state estimation method according to claim 10, wherein
the estimated state of the targeted chemical substance is at least one of a size of the targeted chemical substance in a production process, a degree of progress in a production process, or whether the state of the targeted chemical substance is a normal state.

12. The state estimation method according to claim 10, the method comprising:
outputting a diagram or an image related to the estimated state of the targeted chemical substance.

13. The state estimation method according to claim 10, wherein
the first time series data is at least one of time series data of a temperature in a process of producing the targeted chemical substance, time series data of a sound emitted by a production device that produces the targeted chemical substance, and time series data of a vibration of the production device.

14. The state estimation method according to claim 10, the method comprising:
estimating a time until production of the targeted chemical substance is completed; and
outputting the estimated time.

15. The state estimation method according to claim 10, the method comprising:
when a characteristic value indicating an estimated state of the targeted chemical substance satisfies a predetermined condition criterion,
outputting information indicating that the production is completed.

16. The state estimation method according to claim 10, the method comprising:
estimating a progress status and advice of a production process based on the estimated state and a production time from a start of production of the targeted chemical substance until the state is reached, and
outputting the progress status and the advice.

17. The state estimation method according to claim 10, wherein
the estimation model is generated by further machine learning on a manufacturing condition of the targeted chemical substance.

18. A non-transitory program recording medium recording a state estimation program for causing a computer to execute the steps of:
acquiring first time series data pertaining to a production environment of a targeted chemical substance;
extracting a feature amount of the first time series data;
estimating a state of the targeted chemical substance using an estimation model trained, through machine learning, on a relationship between a state of the targeted chemical substance and a feature amount of second time series data pertaining to the production environment in a production process based on the feature amount of the first time series data; and
outputting the estimated state.
